(19) United States
(12) Patent Application Publication
(10) Pub. No.: US 2025/0260191 A1
(43) Pub. Date: Aug. 14, 2025

(54) Housing

(71) Applicant: TE Connectivity Japan G. K., Kawasaki-shi (JP)

(72) Inventor: Masaaki Saito, Kawasaki-shi (JP)

(73) Assignee: TE Connectivity Japan G. K., Kawasaki-shi (JP)

(21) Appl. No.: 19/052,727

(22) Filed: Feb. 13, 2025

(30) Foreign Application Priority Data
Feb. 14, 2024 (JP) 2024-020127

(51) Int. Cl. H01R 13/506; H01R 13/415

(52) U.S. Cl. CPC H01R 13/506; H01R 13/415

(57) ABSTRACT

A housing that is to be housed in a receptacle case and to which an electric wire is connected in an inside thereof includes a protrusion. The protrusion extends from a first surface of a side of the housing on which the electric wire is inserted into the inside in a first direction. A dimension from the first surface to a distal end of one side of the protrusion is larger than a diameter of the electric wire.

### CROSS-REFERENCE TO RELATED APPLICATIONS

This application claims the benefit of the filing date under 35 U.S.C. § 119(a)-(d) of Japanese Patent Application No. 2024-020127, filed on Feb. 14, 2024.

### FIELD OF THE INVENTION

The present invention relates to a housing and, more particularly, to a housing for an electrical connector.

### BACKGROUND OF THE INVENTION

Electrical connectors for motors may need to be low profile, depending on the application of where the motor is attached. Elements of small parts of low-profile electrical connectors tend to be thin, which creates a risk that the parts may be damaged when a large load is applied.

A housing is attached to a core wire which, after forming work, should be connected to a connector body without applying a large load to the small parts of the low-profile electrical connector. However, if the housing is forcibly attached to the connector body in a state where core wires are overlapping each other or in a state where the dimensions after the forming work of the core wire are not within the range of the dimensions allowed to house the housing in the connector body, the connector body or the housing may become defective. The forming work of the core wire and the work of attaching the housing to the connector body depend on an operator.

Japanese patent application No. JP2018-206501A discloses an electrical connector in which, by opening the upper part of the cable insertion port provided in the housing, work can be performed on the cable from the opened portion. However, JP2018-206501A does not disclose the forming work of core wires after connecting the cable to be inserted into the cable connector and the terminal to be housed in the cable connector.

### SUMMARY OF THE INVENTION

A housing that is to be housed in a receptacle case and to which an electric wire is connected in an inside thereof includes a protrusion. The protrusion extends from a first surface of a side of the housing on which the electric wire is inserted into the inside in a first direction. A dimension from the first surface to a distal end of one side of the protrusion is larger than a diameter of the electric wire.

### BRIEF DESCRIPTION OF DRAWINGS

The invention will now be described by way of example with reference to the accompanying figures, of which:

FIG. 1 is an isometric view of a housing according to an exemplary embodiment;

FIG. 2 is a side view of the housing of FIG. 1;

FIG. 3 is a top view of the housing of FIG. 1;

FIG. 4 is an isometric view of a receptacle case according to an exemplary embodiment;

FIG. 5 is a cross sectional view after core wires are attached to the housing of FIG. 1;

FIG. 6 is a cross sectional view of the path of housing the housing of FIG. 1 in the receptacle case of FIG. 4;

FIG. 7 is a cross sectional view of housing the housing of FIG. 1 in the receptacle case of FIG. 4 further along the path; and

FIG. 8 is a cross sectional view of the housing of FIG. 1 housed in the receptacle case of FIG. 4.

### DETAILED DESCRIPTION

Referring to the accompanying drawings, a housing 10 according to an exemplary embodiment of the present invention and a receptacle case 100 in which the housing 10 is housed will be described below. For convenience of explanation, as shown in each drawing, the direction in which the housing 10 and the receptacle case 100 are housed is a first direction Z, the upper side and the lower side in the first direction Z is (U) and (D) respectively, a second direction X is orthogonal to the first direction Z, and a third direction Y is orthogonal to the second direction X. The front and the rear in the second direction X is (F) and (B) respectively, and the right direction and left direction of the third direction Y is (R) and (L) respectively.

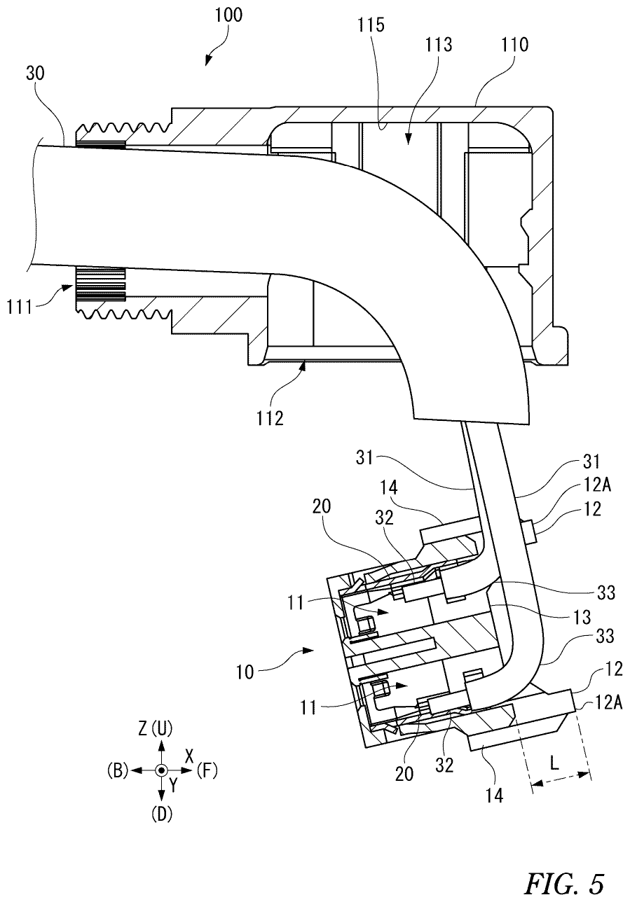

As shown in FIG. 5, a cable 30, for example, is connected to the inside of the housing 10. The cable 30 has a power core wire for supplying power to a servo motor, a brake core wire for operating a holding brake, an encoder core wire for detecting the position of the drive unit, and so on. The housing 10, to which each of these core wires is connected, is mated with a terminal unit after the core wires are housed in the receptacle case 100 and is connected to a terminating end of the servo motor via the terminal unit.

[The cable 30, as shown in FIGS. 5-8, is composed of ten core wires 31 as electric wires, an interposition that covers the surrounding of the ten core wires 31 and is composed of cotton yarn or the like, a braided shield that covers the interposition, and a sheath that covers the braided shield. The interposition, braided shield, and sheath are referred to as the protective layer. A portion of a core wire 31, in which the coating with insulating material has been removed and the conductive element is exposed is referred to as a core wire body portion 32, and the portion coated, is referred to as a core wire 31.

As shown in FIGS. 5-8, the housing 10 comprises a terminal housing section 11, in which a crimp terminal 20 as a terminal is to be housed, and a protrusion 12, which serves as a criterion for determining whether the forming work of the core wire 31 has been performed as specified, are formed. As used throughout the specification, one intended meaning of “forming work” is as follows: the “forming work” is the bending of the core wire 31, as shown in FIGS. 5-8, from a straight state. The housing 10 is formed as an integral piece by injection molding a resin material, which is an electrically insulating material.

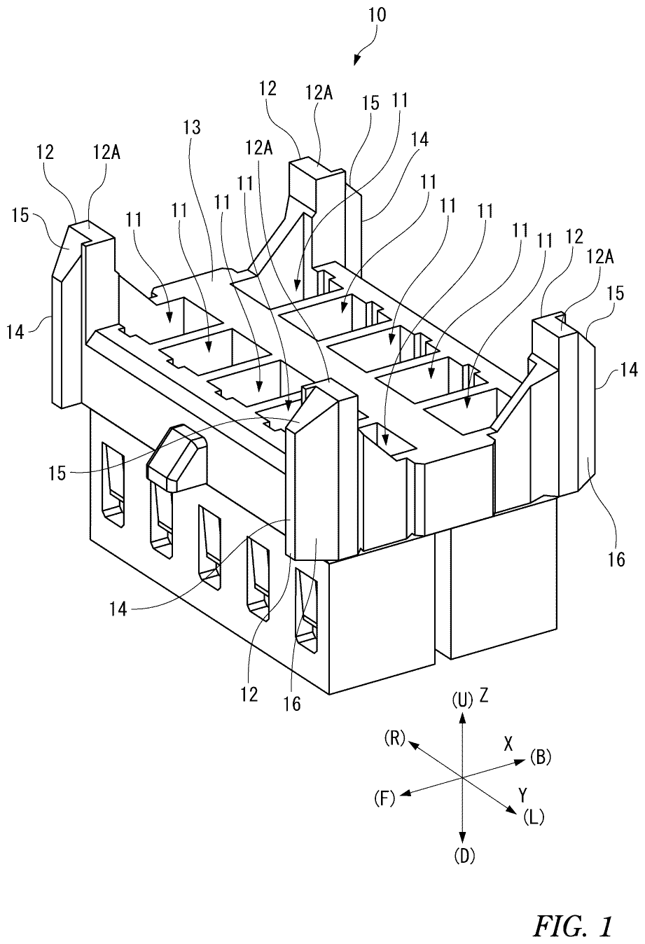

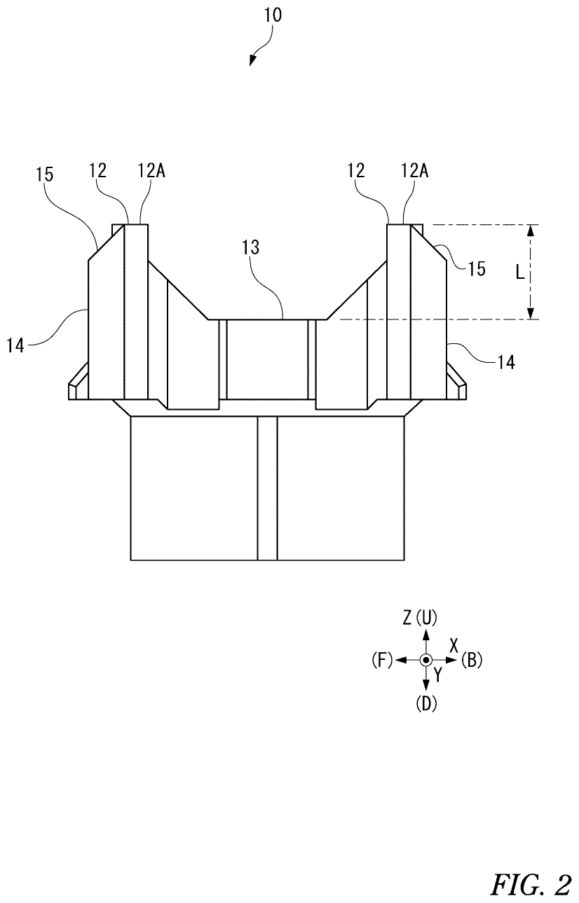

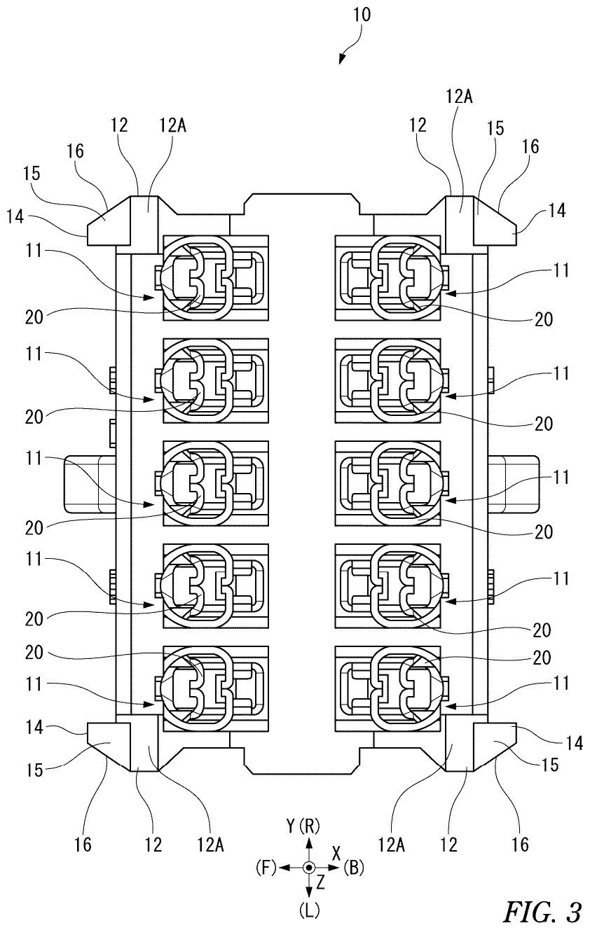

The protrusion 12, as shown in FIGS. 1-3 and 5-8, serves as a guide when the housing 10 is housed in the receptacle case 100, as well as serving as a criterion to determine whether the forming work of the core wire 31 has been performed as specified. As shown in FIG. 3, the protrusion 12 is formed on the four corners of the housing 10. The protrusion 12, as shown in FIG. 2, extends from the first surface 13 of the housing 10 to the upper side U in the first direction Z when the direction in which the core wire 31 is attached to the crimp terminal 20 is the upper side U in the first direction Z.

As shown in FIGS. 1-3 and 5-8, the protrusion 12 has a guide 14 projecting outwardly from the first surface 13. At the distal end portion of the guide 14 on the U (upper) side in the first direction Z, a chamfer 15, as shown in FIGS. 1-3 and 6-7, is formed in the second direction X on the outer side of the housing 10. As shown in FIGS. 1, and 3, an oblique surface 16 that is chamfered is formed on the four protrusions 12. The guide 14 extends from the first surface 13 to the D (lower) side as the other side in the first direction Z.

As shown in FIGS. 2 and 5-8, the dimension L from the first surface 13 to the distal end 12A of the protrusion 12 is larger than the diameter of any of the core wires 31 included in the cable 30.

As shown in FIG. 1, mutual spacing between two protrusions 12 is one-half or more of the dimension in the third direction Y as the longitudinal direction of the first surface 13. By making the mutual spacing between the two protrusions 12 one-half or more of the dimension of the first surface 13 in its longitudinal direction, it is easier to visually check whether the forming work of the core wire 31 is being carried out as specified. As shown in FIG. 1, in the present embodiment, the shape of the first surface 13 is rectangular, and since the dimension in the third direction Y is larger than the dimension in the second direction X, the third direction Y is the longitudinal direction of the first surface 13. When the shape of the first surface 13, when viewed in a plan view, is square, circular, or the like, that is, when the dimension in the second direction X and that in the third direction Y are the same, the same dimension in the second direction X and the third direction Y is used as the dimension in the longitudinal direction.

As shown in FIGS. 5-8, the core wire body portion 32 of the core wire 31 of the cable 30 inserted into the receptacle case 100 is crimped to the crimp terminal 20. A terminal unit, for housing a plurality of terminals, is mated from the lower side D of the housing 10. The terminals housed in the terminal unit are made conductive with the crimp terminals 20.

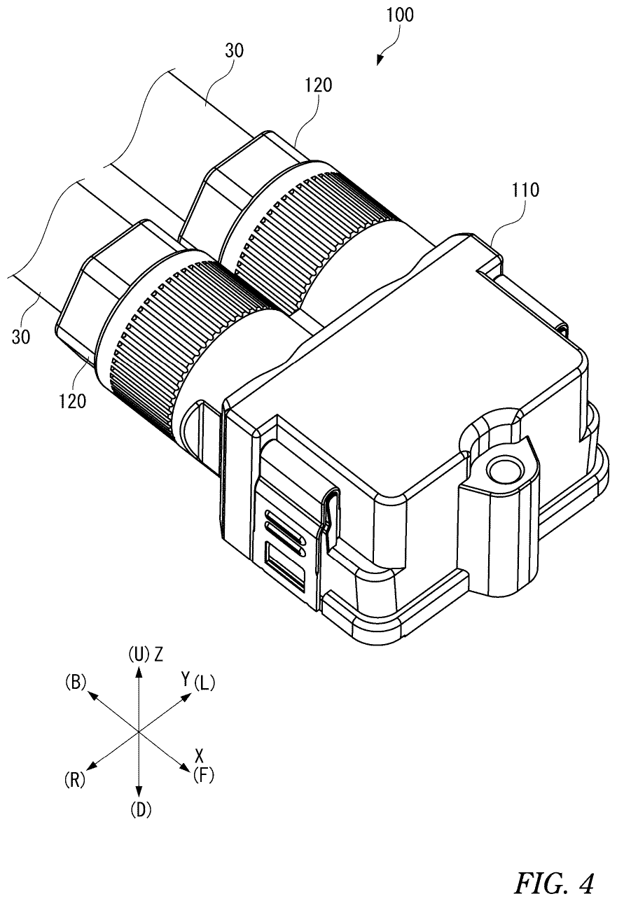

As shown in FIG. 4, a pair of cables 30 are connected to the receptacle case 100 from the rear B in the second direction X. The receptacle case 100 houses the housing 10 to which the core wires 31 are attached.

As shown in FIG. 2, the receptacle case 100 has a case body 110 to be housed along with the housing 10, a clamp 120 for securing the cable 30 inserted into the case body 110, and a packing. The case body 110, as shown in FIGS. 5-8, is provided with a first opening 111 at the rear B in the second direction X and a second opening 112 at the lower side D in the first direction Z. The case body 110 is also provided with a housing section 113. The housing section 113 houses the housing 10 after the core wire 31 is attached to the crimp terminal 20, which is housed in the housing 10, thereby completing the forming of the core wire 31.

When the case body 110 is fixed to the cable 30, the cable 30 is first inserted into the ring-shaped packing, and then the cable 30 is inserted into the case body 110. The clamp 120 has a female thread, and the case body 110 has a male thread. In fastening the clamp 120 to the case body 110, the ring-shaped packing is crushed by the case body 110 and the clamp 120, causing the ring-shaped packing to be elastically deformed and to adhere closely to the cable 30, thereby fixing the case body 110 and the cable 30. The case body 110 and the clamp 120 are each formed as an integral piece by injection molding a resin material, which is an electrical insulating material.

The procedures for attaching the core wire 31 to the housing 10 and for forming the core wire 31 are now described in reference to FIG. 5. In FIGS. 5-8, the hatched indication for the cross section for the cable 30 is omitted.

As shown in FIG. 5, an operator inserts the cable 30 through the first opening 111 and the second opening 112. The operator removes the protective layer at the distal end of the cable 30 protruding from the second opening 112 to expose the core wire 31. The operator also removes the coating of the core wire 31 to expose the core wire body portion 32. The operator then crimps the crimp terminal 20 to the core wire body portion 32. The operator houses the crimp terminal 20 that is crimped to the core wire body portion 32 in the terminal housing section 11 of the housing 10. In the present embodiment, ten crimp terminals 20 that are crimped to ten core wires 31 are each housed in the terminal housing section 11 of the housing 10. At this time, the core wire 31 is attached in the direction in which the protrusion 12 of the housing 10 extends.

The direction of the core wire 31, after it is attached to the housing 10, is changed from a straight state. As shown in FIGS. 5-8, a bending section 33 is provided to bend the core wire 31. When bending the core wire 31 from the straight state, the operator carries out the forming work so that a part of the core wire 31 does not exceed the distal end 12A of the protrusion 12.

Since the protrusion 12 is formed on the housing 10, by visually checking whether a part of the core wire 31 after being formed by the operator exceeds the distal end 12A of the protrusion 12, it is easy to determine whether the forming work of the core wire 31 has been performed as specified. In addition, for example, by placing a flat plate against the distal end 12A of the protrusion 12, and checking whether the core wire 31 is in contact with the flat plate, it is easy to determine whether the core wire 31 after being formed is within the dimension L from the first surface 13 to the distal end 12A in the first direction Z and whether the forming work of the core wire 31 has been performed as specified.

If the ten core wires 31 are each attached to the crimp terminal 20 through free paths, for example, it may be impossible to house the housing 10 in the receptacle case 100 due to the core wires 31 intersecting each other and overlapping in the first direction Z. Also, if, for example, the radius of curvature of the bending section 33 of the core wire 31 is increased and the forming of the core wire 31 is performed so that it is far away from the first surface 13 of the housing 10 (as in this case and some other cases) will not be able to reach a predetermined position in the first direction Z of the receptacle case 100 and will be unable to be housed.

When connecting the core wires 31 drawn from the cable 30 to the housing 10, they can be arranged regularly so that they do not overlap each other in the first direction Z. Furthermore, the forming of the core wires 31 may be performed so that they pass close to the first surface 13 of the housing 10.

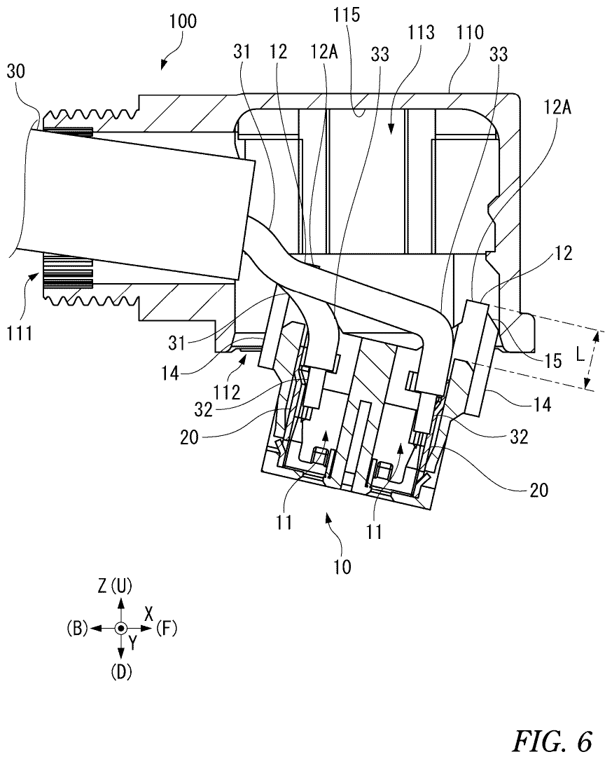

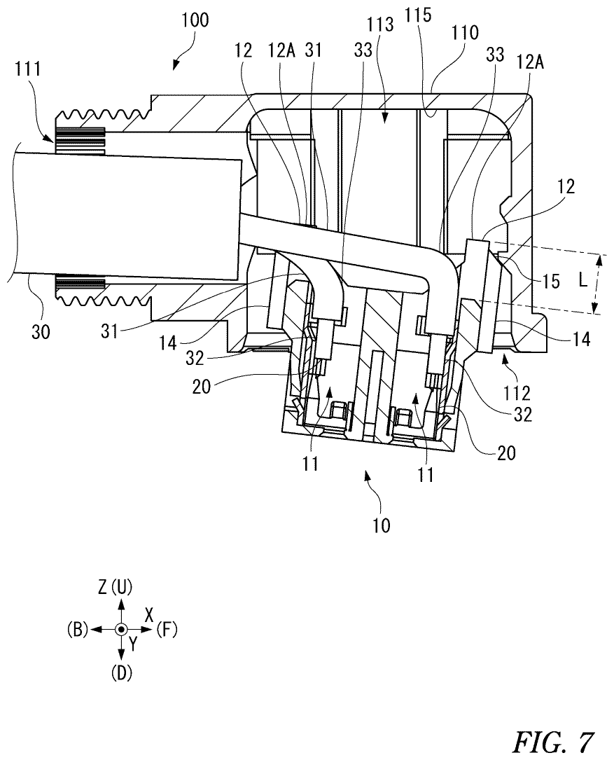

After the forming of the core wires 31 is completed, the housing 10 is housed in the housing section 113. As shown in FIGS. 6-7, the housing 10 is inserted into the housing section 113 while tilting the housing 10 toward the F (front) side in the second direction X. The cable 30 is then pulled from the first opening 111 side to house the housing 10 in the housing section 113. When housing the housing 10 in the housing section 113, the guide 14 of the protrusion 12 is to precede other elements of the housing 10. The chamfer 15 formed on the outside of the housing 10 in the second direction X of the guide 14 makes snagging on the entrance portion of the second opening 112 in the lower side D or on the protruding portion of the inner wall of the receptacle case 100 less likely to occur, thereby preventing the housing 10 from being forcibly inserted into the receptacle case 100. Accordingly, it is possible to prevent excessive load on the housing 10 and the receptacle case 100 from occurring.

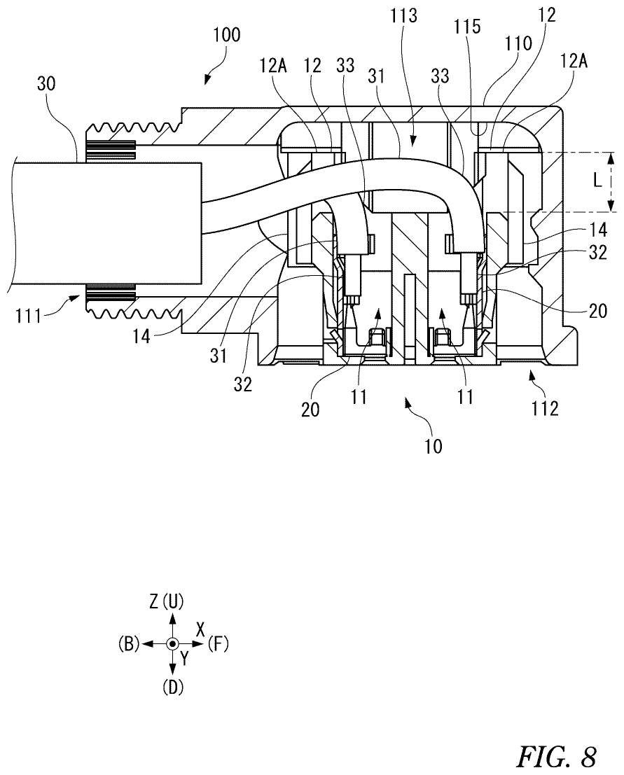

As shown in FIG. 8, when the housing 10 is in a housing completion position of the housing section 113, the terminal unit is mated from the lower side D of the housing 10, and the terminal set and the receptacle case 100 are fixed by fasteners. In addition, the clamp 120 is fastened to the case body 110 to fix the cable 30 to the case body 110. The dimension L as the length of the protrusion 12 is set to a dimension where the distal end 12A of the protrusion 12 does not come into contact with a ceiling surface 115 of the receptacle case 100 opposite the first surface 13 when the housing 10 has reached the housing completion position of the housing section 113. That is, the dimension L as the length of the protrusion 12 is smaller than the dimension of the distance between the first surface 13 and the ceiling surface 115.

The housing 10, as described above, allows for easily determining, by visual inspection, whether the forming work of the core wire 31 has been performed as specified by visually checking whether a part of the core wire 31 after forming exceeds the distal end 12A of the protrusions 12. If, in a low-profile electrical connector, it is easy to determine whether the forming of the core wire is appropriate, the work of forming the core wire and the work of attaching a housing to the connector body will be less dependent on the operator. The housing 10 is also less likely to snag on elements of the receptacle case 100, as described above, thereby preventing the housing 10 from being forcibly inserted into the receptacle case 100. Accordingly, excessive load on the housing 10 and receptacle case 100 can be prevented.

Other than the above, in a range not deviating from the gist of the present invention, it is possible to select among the configurations given in the above embodiment or change to another configuration as appropriate.

1. A housing that is to be housed in a receptacle case and to which an electric wire is connected in an inside thereof, comprising:
a protrusion extending from a first surface of a side of the housing on which the electric wire is inserted into the inside in a first direction, a dimension from the first surface to a distal end of a side of the protrusion is larger than a diameter of the electric wire.

2. The housing of claim 1, wherein the protrusion is one of at least two protrusions formed on the housing, a mutual spacing between the at least two protrusions is greater than or equal to one-half of a dimension of the first surface in a longitudinal direction.

3. The housing of claim 2, wherein a protrusion is formed on each of four corners of the first surface.

4. The housing of claim 3, wherein each protrusion has a guide outwardly projecting from the first surface.

5. The housing of claim 4, wherein the guide extends along the protrusion in the first direction to a side of the protrusion opposite the first surface.

6. The housing of claim 1, wherein a dimension from the first surface to a distal end of the protrusion is smaller than a dimension of a distance between the first surface and the receptacle case when the housing is housed in the receptacle case.

7. A housing, comprising:
a first surface;
a protrusion extending from the first surface in a first direction; and
an inside receiving an electric wire, a dimension from the first surface to a distal end of a side of the protrusion is larger than a diameter of the electric wire.

8. The housing of claim 7, further comprising a terminal housing section extending through the first surface.

9. The housing of claim 8, wherein a crimp terminal is housed in the terminal housing section.

10. The housing of claim 8, wherein the housing has a plurality of terminal housing sections, each terminal housing section houses one crimp terminal.

11. The housing of claim 7, wherein the protrusion has a guide, the guide has a chamfer formed thereon.

12. The housing of claim 11, wherein the guide projects outwardly from the first surface.

13. An electrical connector, comprising:
a cable having an electric wire, the electric wire has an end;
a housing having a first surface, a protrusion extending from the first surface in a first direction, and an inside receiving the end of the electric wire, a dimension from the first surface to a distal end of a side of the protrusion is larger than a diameter of the electric wire; and
a receptacle case having a case body, the case body has a housing section that houses the housing.

14. The electrical connector of claim 13, wherein the receptacle case has a clamp abutting the case body, the clamp fixes the cable to the case body.

15. The electrical connector of claim 13, wherein the case body has a first opening and a second opening perpendicular to the first opening, the cable passes through the first opening.

16. The electrical connector of claim 13, wherein the receptacle case has a ceiling surface, a distal end of the protrusion does not contact the ceiling surface when the housing is housed in the receptacle case.

17. The electrical connector of claim 16, wherein a dimension of the protrusion is smaller than a distance between the first surface and the ceiling surface.

18. The electrical connector of claim 13, wherein the housing has a terminal housing section extending through the first surface, a crimp terminal is housed in the terminal housing section.

19. The electrical connector of claim 18, wherein the cable has a plurality of electric wires and the housing has a plurality of terminal housing sections, each terminal housing section houses one crimp terminal.

20. The electrical connector of claim 19, wherein each electric wire is attached to one crimp terminal.
